(19) United States
(12) Patent Application Publication
(10) Pub. No.: US 2015/0222985 A1
(43) Pub. Date: Aug. 6, 2015

(54) Waterproof Speaker

(71) Applicant: ADD|ON Technology, Taipei City (TW)

(72) Inventors: YU-SHEN LIN, Taipei City (TW); CHI-LIANG CHEN, Taipei City (TW)

(73) Assignee: ADD|ON Technology, Taipei City (TW)

(21) Appl. No.: 14/169,221

(22) Filed: Jan. 31, 2014

(51) Int. Cl. H04R 1/44

(52) U.S. Cl. CPC H04R 1/44; H04R 2420/07

(57) ABSTRACT

A waterproof speaker includes a speaker module and an elastic cover. The speaker module includes a sound generation unit, a control unit and a housing. The control unit is for controlling the sound generation unit to generate sound. The housing is for accommodating the sound generation unit and the control unit. The housing includes a sound emitting area formed with a plurality of through holes corresponding to the sound generation unit. The elastic cover includes a first part for covering outer surfaces of the housing other than the sound emitting area, and a second part for attaching the waterproof speaker to an object.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a waterproof speaker, and more particularly, to a waterproof speaker capable of attaching to an object and improving sound quality.

2. Description of Related Arts

As related technology keeps improving, various types of speakers are developed according to different requirements. For example, a Bluetooth speaker can play back music according to audio signals wirelessly transmitted from an electronic device, such that a user can hear music anywhere when carrying the Bluetooth speaker. However, the Bluetooth speaker of the prior art is not designed to be waterproof, thus the conventional Bluetooth speaker cannot be used in a bathroom when the user is taking a shower. Moreover, the conventional Bluetooth speaker cannot be easily attached to a desired position, such as a position on a wall or a mirror, thus the conventional Bluetooth speaker is not convenient to use.

### SUMMARY OF THE PRESENT INVENTION

The present invention provides a waterproof speaker, comprising a speaker module and an elastic cover. The speaker module comprises a sound generation unit, a control unit and a housing. The control unit is for controlling the sound generation unit to generate sound. The housing is for accommodating the sound generation unit and the control unit. The housing comprises a sound emitting area formed with a plurality of through holes corresponding to the sound generation unit. The elastic cover comprises a first part for covering outer surfaces of the housing other than the sound emitting area, and a second part for attaching the waterproof speaker to an object.

According to an embodiment of the present invention, the housing further comprises a groove arranged at periphery of the sound emitting area, and the first part of the elastic cover comprises a convex structure engaged with the groove.

According to an embodiment of the present invention, the control unit comprises a plurality of buttons, and the first part of the elastic cover comprises a plurality of bumps for pressing the buttons.

According to an embodiment of the present invention, the elastic cover is formed integrally.

According to an embodiment of the present invention, the second part of the elastic cover is formed in a suction cup shape.

According to an embodiment of the present invention, the control unit comprises a wireless chip for receiving audio signals wirelessly.

According to an embodiment of the present invention, the elastic cover is made of silicone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a waterproof speaker of the present invention.

FIG. 2 is a diagram showing a speaker module of the waterproof speaker of the present invention.

FIG. 3 is a diagram showing an elastic cover of the waterproof speaker of the present invention.

FIG. 4 is a cross-sectional view showing a convex structure of the elastic cover engaged with a groove of the speaker module.

### DETAILED DESCRIPTION OF THE PREFERRED EMBODIMENT

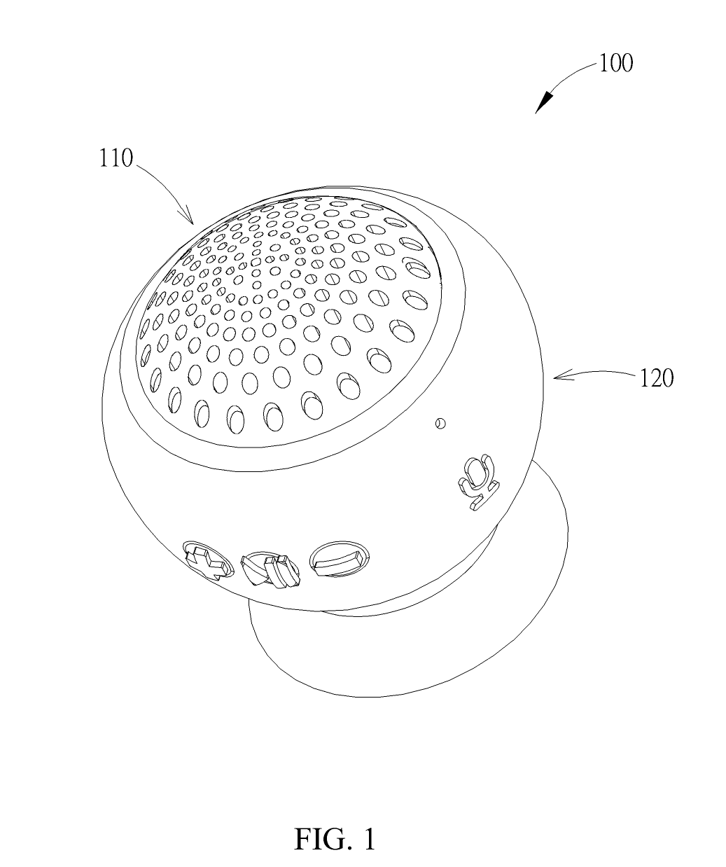

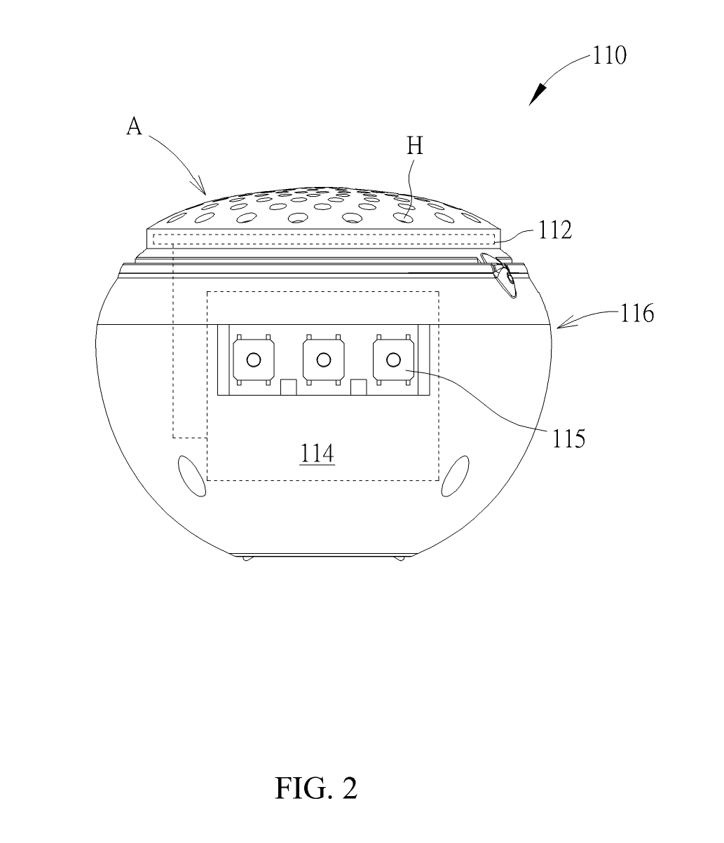

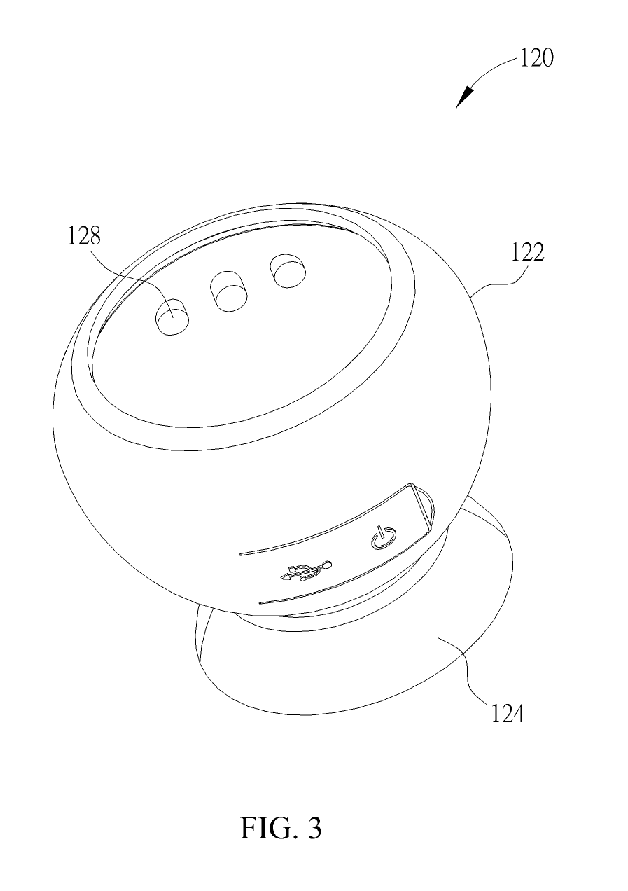

Please refer to FIG. 1 to FIG. 3 together. FIG. 1 is a diagram showing a waterproof speaker 100 of the present invention. FIG. 2 is a diagram showing a speaker module 110 of the waterproof speaker 100 of the present invention. FIG. 3 is a diagram showing an elastic cover of the waterproof speaker 100 of the present invention. As shown in figures, the waterproof speaker 100 comprises a speaker module 110 and an elastic cover 120. The speaker module 110 comprises a sound generation unit 112, a control unit 114 and a housing 116. The sound generation unit 112 can generate sound according to control signals transmitted from the control unit 114. The control unit 114 is electrically connected to the sound generation unit 112 for generating the control signals according to received audio signals, and transmitting the control signals to the sound generation unit 112, in order to control the sound generation unit 112 to generate sound. The control unit 114 can comprises a wireless chip, such as a Bluetooth chip, for receiving audio signals wirelessly from an external electronic device. The housing 116 is for accommodating the sound generation unit 112 and the control unit 114. The housing 116 comprises a sound emitting area A. The sound emitting area A is formed with a plurality of through holes H corresponding to the sound generation unit 112, such that when the sound generation unit 112 generates sound, the sound can be emitted via the through holes H of the sound emitting area A.

The elastic cover 120 comprises a first part 122 and a second part 124. The first part 122 of the elastic cover 120 is for covering most outer surfaces of the housing 116 other than the sound emitting area A, in order to prevent the control unit 114 from being damaged by water. Even though the water can get into the housing 116 from the through holes H, a diaphragm and other components of the sound generation unit 112 can form a barrier to keep the water away from the control unit 114. Therefore, the speaker of the present invention can be waterproof. The second part 124 of the elastic cover 120 can be attached to an object. For example, the second part 124 of the elastic cover 120 can be formed in a suction cup shape, such that the second part 124 of the elastic cover 120 can be attached onto a plane, such as on a wall or a mirror. Therefore, the user can fixed the waterproof speaker 100 of the present invention at a desired position by the second part 124 of the elastic cover 120.

Moreover, since the first part 122 of the elastic cover 120 only allows the sound emitting area A to be exposed, sound waves emitted from the outer surfaces of the housing 116 other than the sound emitting area A can be absorbed by the elastic cover 120, in order to prevent the sound emitted via the through holes H from being interfered by the sound waves emitted from other area of the housing 116. Therefore, sound quality of the waterproof speaker 100 of the present invention can be improved.

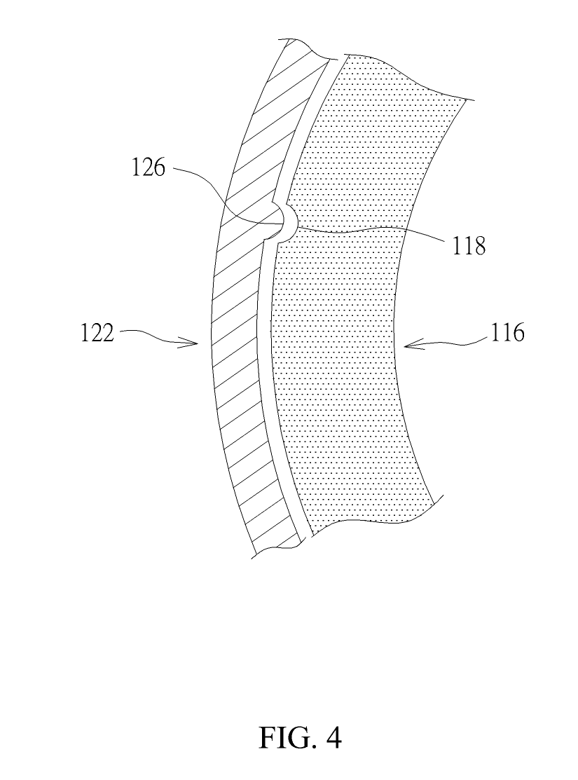

Please refer to FIG. 4, and refer to FIG. 1 as well. FIG. 4 is a cross-sectional view showing a convex structure 126 of the elastic cover 120 engaged with a groove 118 of the speaker module 110. As shown in FIG. 4, in order to increase waterproof capability, the housing 116 can comprise a groove 118 arranged at periphery of the sound emitting area A, and the first part 122 of the elastic cover 120 can comprise a convex structure 126 to be engaged with the groove 118. The convex structure 126 can form a ring for surrounding the sound emitting area A. Therefore, the water can be blocked by the convex structure 126 of the elastic cover 120. In addition, the elastic cover 120 can be formed integrally to further increase waterproof capability.

Besides, the control unit 114 can comprise a plurality of functional buttons 115, such as volume-up, volume-down and play/pause buttons. The first part 122 of the elastic cover 120 can comprise a plurality of inner bumps 128 corresponding to the plurality of buttons 115 for pressing the buttons 115. And a plurality of outer bumps 129 corresponding to the inner bumps 128 are arranged on outer surface of the first part 122 of the elastic cover 120. The plurality of outer bumps 129 can be formed with patterns corresponding to functions of the buttons 115. Therefore, the user can control the waterproof speaker 100 by pressing the outer bumps 129 of the elastic cover 120.

Moreover, a microphone hole 123 can be formed on the first part 122 of the elastic cover 120 for allowing a microphone of the speaker module 110 to collect sound, thus the waterproof speaker 100 can also work as a speaker phone.

In the present embodiment, the elastic cover 120 is made of silicone material. But in other embodiment of the present invention, the elastic cover 120 can be made of other kind of elastic material.

In contrast to the prior art, the waterproof speaker 100 of the present invention can prevent the speaker module 110 from being damaged by the water, such that the user can place the waterproof speaker 100 in a bathroom for enjoying music when taking a shower. In addition, the waterproof speaker 100 can be arbitrarily attached onto a plane, such as on a wall or a mirror, so that the user can fixed the waterproof speaker 100 at a desired position. Besides, the elastic cover 120 of the waterproof speaker 100 can absorb sound waves not emitted via the through holes H of the sound emitting area A, so as to improve sound quality of the waterproof speaker 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A waterproof speaker, comprising:
a speaker module, comprising:
a sound generation unit;
a control unit, for controlling the sound generation unit to generate sound; and
a housing, for accommodating the sound generation unit and the control unit, the housing having a sound emitting area formed with a plurality of through holes corresponding to the sound generation unit; and
an elastic cover, comprising:
a first part, for covering outer surfaces of the housing other than the sound emitting area; and
a second part, for attaching the waterproof speaker to an object.

2. The waterproof speaker of claim 1, wherein the housing further comprises a groove arranged at periphery of the sound emitting area, and the first part of the elastic cover comprises a convex structure engaged with the groove.

3. The waterproof speaker of claim 1, wherein the control unit comprises a plurality of buttons, and the first part of the elastic cover comprises a plurality of bumps for pressing the buttons.

4. The waterproof speaker of claim 1, wherein the elastic cover is formed integrally.

5. The waterproof speaker of claim 1, wherein the second part of the elastic cover is formed in a suction cup shape.

6. The waterproof speaker of claim 1, wherein the control unit comprises a wireless chip for receiving audio signals wirelessly.

7. The waterproof speaker of claim 1, wherein the elastic cover is made of silicone.
